(19) United States
(12) Patent Application Publication
(10) Pub. No.: US 2009/0099847 A1
(43) Pub. Date: Apr. 16, 2009

(54) Template constrained posterior probability

(75) Inventors: Frank Soong, Beijing (CN); Lijuan Wang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/973,735

(22) Filed: Oct. 10, 2007

(51) Int. Cl. G10L 11/00

(52) U.S. Cl. 704/270

(57) ABSTRACT

Detailed herein is a technology which, among other things, reduces errors introduced in recording and transcription data. In one approach to this technology, a method of detecting audio transcription errors is utilized. This method includes selected a focus unit, and selecting a context template corresponding to the focus unit. A hypothesis set is then determined, with reference to the context template and the focus unit. A probability is calculated corresponding to the focus unit, across the hypothesis set.

### BACKGROUND

Human-computer voice interaction, through such approaches as text-to-speech and speech recognition, is an increasingly important topic, and is the subject of significant research efforts. Most such interaction relies upon a combination of complex algorithms and language databases, in order to provide an accurate response in a timely fashion.

One significant problem in this field is that nearly all work must rely upon an underlying well-annotated speech database. For example, text-to-speech synthesis relies upon the accuracy of annotated phonetic labels and corresponding contexts for selecting good acoustic units from a pre-recorded database. However, such a database must be thoroughly examined before it may be relied upon, in order to catch reading or pronunciation errors, transcription errors, incomplete pronunciation lists, and similar issues. Because of the scope of the task, automated measures for potential error detection are both necessary and desirable. Confidence measures are useful, in this field, for verifying speech transcription by assessing the reliability of a focused unit, such as a word, syllable, or phone.

A number of approaches for measuring confidence of speech transcriptions have been utilized. These approaches can be roughly categorized into three major categories. Feature based approaches attempt to assess confidence based on selected features, such as word duration, part of speech, or word graph density, using trained classifiers. Explicit model based approaches used a candidate class model with competing models, and a likelihood ratio test. Posterior probability approaches attempt to estimate the posterior probability of a recognized entity, given all acoustic observations.

### SUMMARY

Detailed herein is a technology which, among other things, reduces errors introduced in recording and transcription data. In one approach to this technology, a method of detecting audio transcription errors is utilized. This method includes selected a focus unit, and selecting a context template corresponding to the focus unit. A hypothesis set is then determined, with reference to the context template and the focus unit. A probability is calculated corresponding to the focus unit, across the hypothesis set.

In another approach, a computer-readable medium having computer-executable instructions is described. In this approach, a focus unit is selected from audio transcription data. A context template is selected corresponding to the focus unit, where the context template is selected to reduce potential errors. A hypothesis set is determined, with reference to the focus unit and the context template, including a number of string hypotheses. A posterior probability corresponding to the focus unit across the hypothesis set is calculated.

Another approach describes a computer system. The computer system has a system memory, a central processing unit (CPU), and a storage device. The computer system is configured to select a focus unit. The computer system is further configured to select a context template corresponding to the focus unit. The computer system is further configured to determine a hypothesis set, with reference to the context template and the focus unit. The computer system is further configured to calculate a probability corresponding to the focus unit across the hypothesis set.

### BRIEF DESCRIPTION OF THE FIGURES

The accompanying drawings, which are incorporated in and form a part of this specification, illustrate embodiments and, together with the description, serve to explain the principles of the claimed subject matter:

FIG. 1 is a block diagram of an exemplary computing system upon which embodiments may be implemented.

FIG. 2 is a depiction of exemplary transaction errors.

FIG. 3 is a depiction of an exemplary template, in accordance with one embodiment.

FIG. 4 is a depiction of several types of context templates, in accordance with one embodiment.

FIG. 5 is a depiction of a compound template, in accordance with one embodiment.

FIG. 6 is a flowchart of a method of calculating a template constrained posterior probability value.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

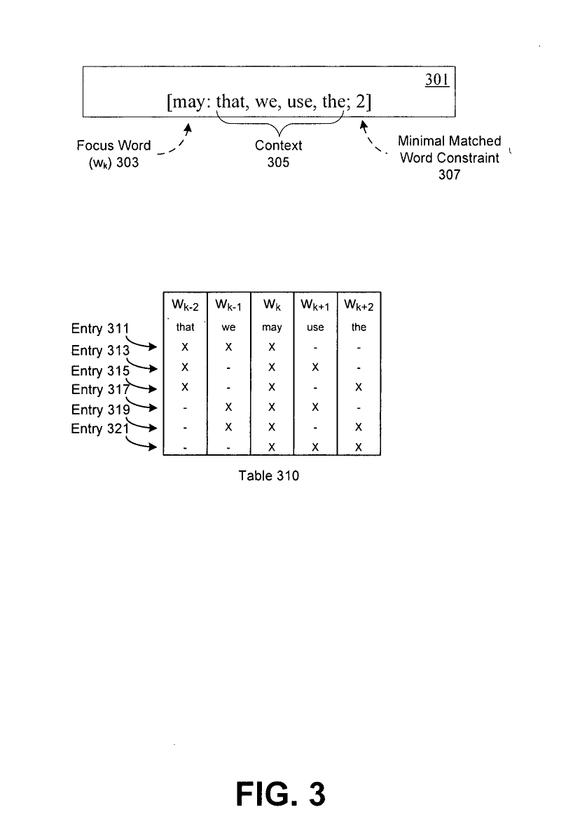

Portions of the detailed description that follows are presented and discussed in terms of a method. Although steps and sequencing thereof are disclosed in a figure herein (e.g., FIG. 3) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices, such as computing system environment 10, typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Template Constrained Posterior

In the embodiments which follow, an approach to measuring confidence of speech transcriptions is described, which utilizes a template constrained posterior (TCP) approach. This template constrained approach uses templates to limit the hypothesis set used in calculating the posterior probability for a selected focus unit. These templates may be tailored to provide a fine degree of granularity, from a very specifically defined context to much broader, loosely defined contexts.

The TC GPP approach examines both the focused unit and the context to the left and right of the focused unit. In this way, this approach better discriminates against competing phones, in that a string hypothesis with competing phones is less likely to also match the (partial) context supplied by the template than a hypothesis containing the actual phone. As such, hypotheses contain the competing phone will be less likely to be included in the TCP calculation, offering an advantage over traditional GPP approaches.

Further, the TCP approach provides additional robustness against incorrect time boundaries. Whereas in a standard GPP approach, the focus unit is expected to appear within a narrow timeframe, TCP allows for a broader timeframe to be included in the calculation, in order to allow for examination of context. As such, the TCP approach is more robust against incorrect time boundaries, e.g., such as those caused by insertion, deletion, or substitution errors.

### Generalized Posterior Probability

Generalized posterior probability (GPP) is sometimes used in speech transcription analysis to calculate a confidence measure for verifying hypothesized entities at phone, syllable, or word levels. For a selected focus unit, e.g., a word, the acoustic probability and the linguistic probability of that word are compared against the total set of possible hypotheses to generate a ratio. The higher the calculated GPP, the more probable that the focus unit was correctly transcribed. Table 1, below, provides a broad overview of this relationship.

TABLE 1
$p ( w \vert {x}_{1}^{T} ) = \frac{{\sum }_{h ∈ H} p ( h )}{{\sum }_{h ∈ R} p ( h )} , H ⋐ R$
Where, p(h) = [Acoustic Probability] [Linguistic Probability]

Let R represent the search space, which includes all possible string hypotheses for a given sequence of acoustic observations x₁^{T}. In practice, the search space R is usually reduced to a pruned space, for example a word graph. H, a subset of R, contains all string hypotheses that include/cover the focused word “w” by a given time range between starting and ending points. The posterior probability of “w” can be obtained by the equation shown in Table 1, i.e., the sum of the probabilities of string hypotheses in H divided by the sum of probabilities of string hypotheses in R. Therefore, finding the right hypothesis subset H of R is a critical step in computing the posterior probability P(w|x₁^{T}) for verification. As shown here, the reliability of one hypothesis string is the product of the acoustic and linguistic probabilities. The acoustic probability is an examination of the waveform of the selected time frame, compared against an acoustic database. The linguistic probability is a language analysis, e.g., how likely the focus word is to appear in this given location. Table 2, below, provides an example equation for calculating generalized posterior probability.

TABLE 2
$p ( [ w ; s , t ] \vert {x}_{1}^{T} ) = {\sum }_{{N , {[ w ; s , t ]}_{1}^{N}}_{{∃ n , 1 \leq n \leq N}_{{w = {w}_{n}}_{[ s , t ] ⋂ [ {s}_{n} , {t}_{n} ] \neq φ}}}} \frac{{\prod }_{n = 1}^{N} {p}^{α} ( {x}_{{s}_{n}}^{{t}_{n}} \vert {w}_{n} ) \cdot {p}^{β} ( {w}_{n} \vert {w}_{1}^{N} )}{p ( {x}_{1}^{T} )}$

As noted previously, GPP has several shortcomings. First, as the word graph, or language space, becomes richer, the probability of a competing phone increases. Second, selection of the language space is dependent upon the provided time frame; if the start or end time is inaccurate, e.g., because of an earlier deletion, substitution, or addition error, the probability that the focus unit appears within that time frame is substantially altered.

### Templates and Posterior Probability

Through the use of templates, embodiments seek to avoid these shortcomings in GPP. Use of templates allows a “sifting” of hypotheses; only those hypotheses which match both the focus unit and the specified context are included in the language space, which leads to higher calculated probability results for the focus unit, and greater confidence. Moreover, because these templates may be constructed in a number of ways, TCP offers a granular and customizable approach to calculating confidence measures. Templates offer a degree of flexibility ranging from traditional GPP-style performance, e.g., where a template specifies no context for the focus unit, to a very specific approach, e.g., where the template specifies significant context for the focus unit.

It is understood that while embodiments described herein may speak of a specific type of focus unit, e.g., a word, embodiments are well suited to applications involving a wide variety of approaches. Specifically, embodiments are well suited to applications involving phones, syllables, words, phrases, and sentences, as well as other divisions of speech.

### Basic Computing Device

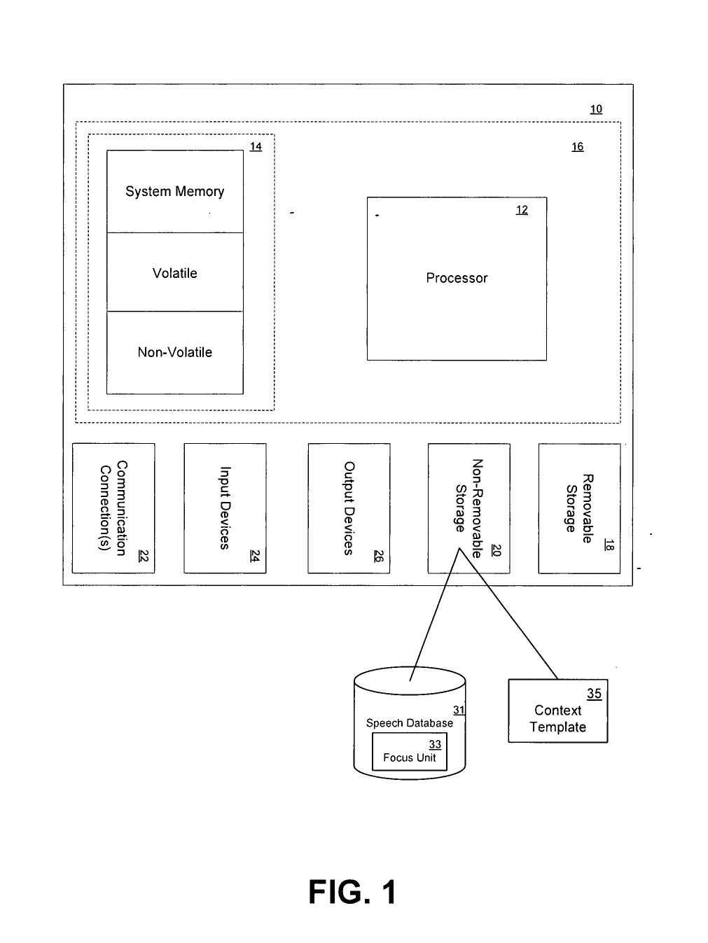

With reference to FIG. 1, an exemplary system for implementing embodiments includes a general purpose computing system environment, such as computing system environment 10. In its most basic configuration, computing system environment 10 typically includes at least one processing unit 12 and memory 14. Depending on the exact configuration and type of computing system environment, memory 14 may be volatile (such as RAM), non-volatile (such as ROM, flash memory, etc.) or some combination of the two. This most basic configuration is illustrated in FIG. 1 by dashed line 16. Additionally, computing system environment 10 may also have additional features/functionality. For example, computing system environment 10 may also include additional storage (removable and/or non-removable) including, but not limited to, magnetic or optical disks or tape. Such additional storage is illustrated in FIG. 1 by removable storage 18 and non-removable storage 20. Computer storage media includes volatile and nonvolatile, removable and non-removable media implemented in any method or technology for storage of information such as computer readable instructions, data structures, program modules or other data. Memory 14, removable storage 18 and nonremovable storage 20 are all examples of computer storage media.

Computing system environment 10 may also contain communications connection 22 that allow it to communicate with other devices. Communications connection 22 is an example of communication media.

Computing system environment 10 may also have input device(s) 24 such as a keyboard, mouse, pen, voice input device, touch input device, etc. Output device(s) 26 such as a display, speakers, printer, etc. may also be included. Specific embodiments, discussed herein, combine touch input devices with a display, e.g., a touch screen. All these devices are well known in the art and need not be discussed at length here.

As depicted in the current embodiment, nonremovable storage 20 is used to store information relating to calculating TCP probability values, such as speech database 31, which contains focus unit 33, and context template 35. In other embodiments, these and other elements may be located in other locations, e.g., removable storage 18, or on a remote storage device reached via communications connection 22. Further, in some embodiments, these or other elements may be held in system memory.

### Exemplary Audio/Transcription Errors

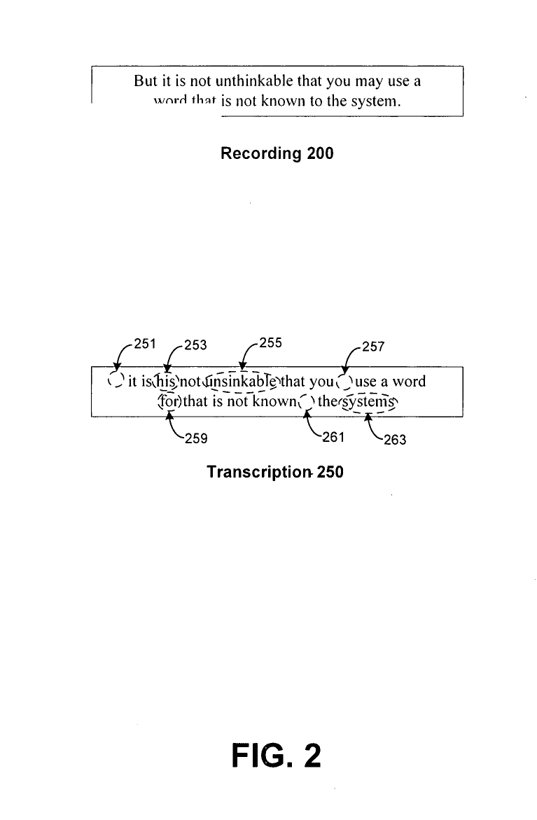

With reference now to FIG. 2, exemplary transcription errors are depicted. An audio recording of line 200, e.g., a wav file, may result in transcription 250. Transcription 250 contains several types of common errors. Errors 251, 257, and 261 are deletion errors, e.g., where a word present in the source recording is not included in the transcription. Errors 253 and 259 are addition errors, e.g., where the transcription includes a word not present in the source recording. Errors 255 and 263 are substitution errors, e.g., where the transcription has replaced a word from the source recording with a different word.

### Exemplary Template

With reference now to FIG. 3, an exemplary template 301 is depicted, in accordance with one embodiment. Template 301 is drawn from source recording 200 and transcription 250. It is understood that while template 301 is shown as including specific, enumerated features, elements, and arrangements, embodiments are well suited to applications involving additional, fewer, or different features, elements, or arrangements.

Template 301 is shown as being a triple, containing a focus word 303, a context 305, and a minimal matched word constraint 307. The focus word 303, Wk, specifies the word that is currently being examined. In different embodiments, this may be a phone, syllable, a word, or even a phrase or sentence. In the depicted embodiment, source audio 200 indicates the presence of the word “may”, while transcription 250 does not include this word (e.g., error 257).

The context 305, shown here as including four words wₖ₋₂, wₖ₋₁, wₖ₊₁, and wₖ₊₂, specifies some of the context of which should surround the focus word. In the depicted embodiment, the number of context words which need to be matched may vary, e.g., as minimal matched word constraint 307 changes. However, in this embodiment, the position of the context words is fixed, e.g., the word “that” is a context match if and only if it appears in the wₖ₋₂ position in a hypothesis. In other embodiments, other implementations are utilized.

The minimal matched word constraint 307, in this embodiment, is set equal to two. Here, the minimal matched word constraint means that at least two context words need to match, in order for a string hypothesis to be included in the considered language space. In this embodiment, the minimal matched word constraint 307 is equal to half of the context words provided in context 305. In other embodiments, this relationship may vary.

Table 310 depicts a number of context constrained patterns, and specified by template 301. Entries 311, 313, 315, 317, 319, and 321 each include the focus word 303, wₖ, as well as at least two of the context words provided by context 305. When generating a language space for TCP analysis of focus word 303, any string hypothesis which conforms to at least one of the entries depicted in table 310 should be included in the resulting bounded language space. Similarly, any string hypothesis which does not conform to one of these entries can be excluded from the language space. The resulting language space is therefore more carefully tailored to the context of the focus word, which allows for an increased confidence measure in analyzing the focus word.

### Variations on Templates

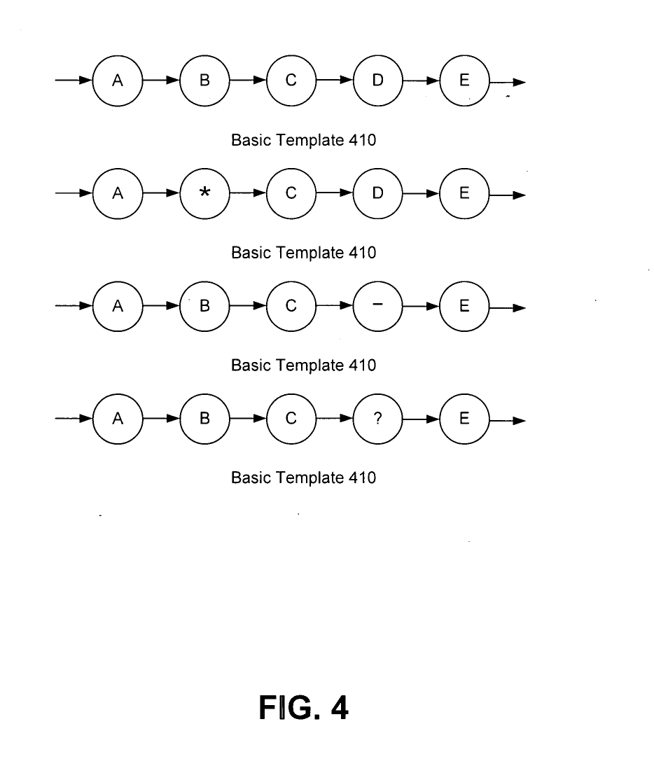

In different embodiments, different approaches can be used in generating templates. For example, the number of context words and the minimal matching constraint can vary, as can the relationship between these numbers. Moreover, the confidence required for these context words can be relaxed as well, e.g., such that a partial match of the context word is sufficient, or that all words which sound similar can be included in the context. Further, a number of different basic templates can be used, as illustrated in FIG. 4.

With reference now to FIG. 4, several types of context template are illustrated, in accordance with one embodiment. While FIG. 4 shows several context templates having specific, enumerated features, elements, and arrangements, it is understood that embodiments are well suited to applications involving additional, fewer, or different elements, features, and arrangements.

Basic template 410 depicts the simplest type of template, ABCDE, where C is the focus unit, and AB and DE are the left and right context, respectively. Template 420, A*CDE, includes a wild-card, *, to indicate that the template does not care what appears in that particular position: A*CDE matches equally with AACDE and AFCDE, or with ACDE. Template 430, ABC_E, includes a blank, _, to indicate that, e.g., a pause or silence should appear in this position. Template 440, ABC?E, includes a question mark, ?, to indicate that the word which appears in this position has not been identified yet. In other embodiments, other template variations are utilized.

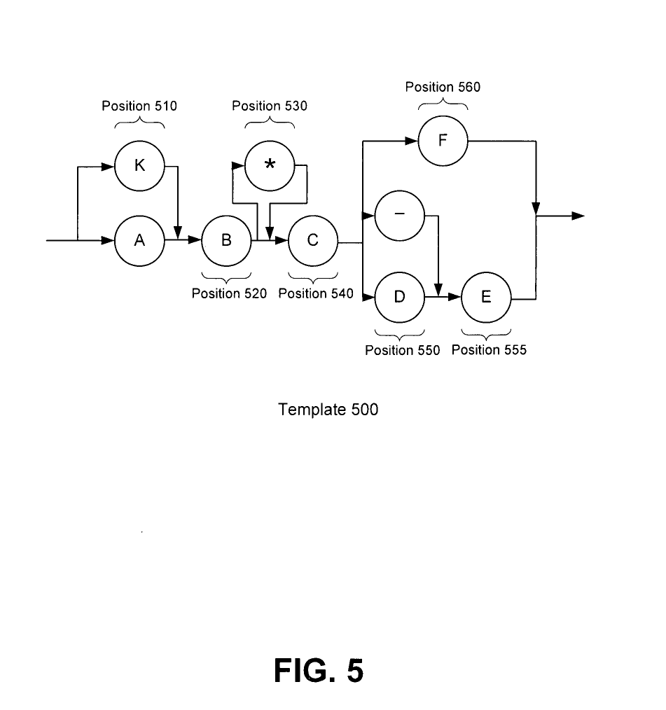

In some embodiments, these basic templates can be combined to construct a compound template, such as that depicted in FIG. 5. Compound template 500 uses a combination of the basic templates, to construct a more complicated template. With reference to compound template 500, a matching string hypothesis may include either A or K in position 510, include B at position 520, may include any element at position 530, includes C at position 540. Then the template branches, such that a matching string hypothesis either includes F at position 560, or else either _ or D at position 550 and E at position 555. Depending upon the specified minimal matching constraint and whether some or all of these elements can be partially matched, the language space generated from compound template 500 may be substantially larger than one generated from a basic template.

### Method of Calculating Template Constrained Posterior

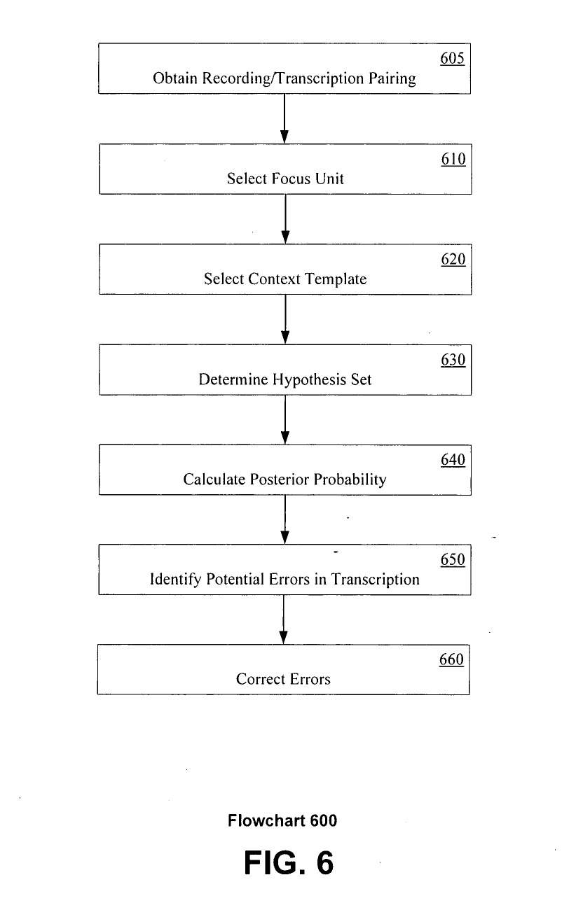

With reference now to FIG. 6, a flowchart 600 of a method of calculating a template constrained posterior (TCP) is depicted, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

With reference now to step 605, a recording of speech and a transcription of that recording are obtained. In some embodiments, this recording and transcription pair may represent a set of training data for a speech-recognition or text-to-speech system. In other embodiments, the recording/transcription data may come from another source.

With reference now to step 610, a focus unit is selected. In different embodiments, the focus unit may be a phone, a syllable, word, a sentence, or some other desirable part of speech. In different embodiments, different approaches are used for selecting such a focus unit. For example, in one embodiment, TCP may be utilized in situations where traditional GPP yields a confidence measure lower than a certain threshold, or indicates several possible matches within a set range of each other. In another embodiment, TCP may be utilized for every focus unit in a given body of data, e.g., every word in a recorded dialogue may be utilized as a focus word. In other embodiments, other approaches are utilized.

With reference now to step 620, an appropriate template is selected. In some embodiments, a number of preformed templates may be provided, e.g., a template may be provided for a particular focus word, with commonly occurring context words used to flesh out the template. In another embodiment, a framework for several different templates may be provided, and the appropriate framework is then selected, and context words added from the source material, e.g., basic template 410 is selected as a framework, and context words are drawn from recognized words in audio recording 200. In another embodiment, templates may be manually created. In other embodiments, other approaches for template selection and/or creation are utilized.

With reference now to step 630, an appropriate hypothesis set is determined. In some embodiments, the template selected in step 620 is used to limit or bound the language space for calculating the posterior probability. Depending on how stringent the template constraints are, the hypothesis set that is examined may be greatly narrowed, over traditional GPP approaches.

With reference now to step 640, a posterior probability is calculated within this hypothesis set. In different embodiments, different approaches may be utilized for calculating posterior probability. In one embodiment, where all string hypotheses that match template T are used to form the hypothesis set H(T), the calculation presented below in Table 3 is utilized for calculating the template constrained posterior of the focus unit, wₖ, across all of the string hypotheses in H(T).

TABLE 3
$\begin{matrix}P ( [ {w}_{k} ; {w}_{k - L} {…w}_{k} {…w}_{k + L} ; m ] \vert {x}_{1}^{T} ) = \\ {\sum }_{{N , h = {[ w , s , t ]}_{1}^{N}}_{h ∈ H ( [ {w}_{k} ; {w}_{k - L} {…w}_{k} {…w}_{k + L} ; m ] )}} \frac{{\prod }_{n = 1}^{N} {p}^{α} ( {x}_{{s}_{n}}^{{t}_{n}} \vert {w}_{n} ) \cdot {p}^{β} ( {w}_{n} \vert {w}_{1}^{N} )}{p ( {x}_{1}^{T} )}\end{matrix}$

With reference now to step 650, in some embodiments, the posterior probability calculated during step 640 is utilized to identify potential errors between the audio recording and the transcription. In some embodiments, errors such as deletion, addition, or substitution can be so identified.

With reference now to step 660, in some embodiments, errors can be corrected. In one embodiment, an automated approach is utilized, and the hypothesis with the greatest calculated posterior probability is selected. In another embodiment, a semiautomated approach can be utilized, such that the potential error is presented to a user through a user interface, allowing the user to correct the error. This embodiment may also provide the hypothesis with the greatest calculated posterior probability as a suggested error correction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of detecting audio transcription errors, comprising:
selecting a focus unit;
selecting a context template corresponding to said focus unit;
determining a hypothesis set, with reference to said context template and said focus unit; and
calculating a posterior probability corresponding to said focus unit across said hypothesis set.

2. The method of claim 1, further comprising:
obtaining a recording and transcription pair; and
selecting said focus unit from said recording and transcription pair.

3. The method of claim 2, further comprising:
using said probability to identify a potential error in said recording and transcription pair.

4. The method of claim 3, further comprising:
correcting said potential error.

5. The method of claim 4, wherein said correcting said potential error comprises:
selecting a hypothesis from said hypothesis set with the highest probability.

6. The method of claim 4, wherein said correcting said potential air comprises:
displaying said potential error to a user through a user interface.

7. The method of claim 6, further comprising:
suggesting a hypothesis from said hypothesis set with the highest probability.

8. A computer-readable medium having computer-executable instructions for performing steps comprising:
selecting a focus unit from audio transcription data;
selecting a context template corresponding to said focus unit, said context template selected to reduce potential errors;
determining a hypothesis set, with reference to said focus unit and said context template, said hypothesis set comprising a plurality of string hypotheses; and
calculating a posterior probability corresponding to said focus unit across said hypothesis set.

9. The computer-readable medium of claim 8, further comprising:
obtaining said audio transcription data.

10. The computer-readable medium of claim 8, further comprising:
using said posterior probability to identify a potential error in said audio transcription data.

11. The computer-readable medium of claim 10, further comprising:
correcting said potential error.

12. The computer-readable medium of claim 8, wherein said focus unit comprises a phone.

13. The computer-readable medium of claim 8, wherein said focus unit comprises a syllable.

14. The computer-readable medium of claim 8, wherein said focus unit comprises a word.

15. The computer-readable medium of claim 8, wherein said context template comprises a left context unit and a right context unit.

16. The computer-readable medium of claim 15, wherein each of said plurality of string hypotheses correspond to said left context units, said right context unit, and said focus unit.

17. A computer system, comprising:
a storage device, for storing a focus unit and a context template corresponding to said focus unit; and
a central processing unit (CPU) coupled to the system memory, that is capable of determining a hypothesis set, with reference to said context template and said focus unit, and is further capable of calculating a probability corresponding to said focus unit across said hypothesis set.

18. The computer system of claim 17, wherein said focus unit comprises an element of speech.

19. The computer system of claim 17, wherein said computer system is further configured to calculate a posterior probability.

20. The computer system of claim 17, wherein said context template is selected so as to limit said hypothesis set.
